(19) United States
(12) Patent Application Publication
(10) Pub. No.: US 2020/0216640 A1
(43) Pub. Date: Jul. 9, 2020

(54) PROCESS FOR PRODUCING FIBER COMPOSITE MATERIAL USING HYBRID POLYOL

(71) Applicant: BASF SE, Ludwigshafen am Rhein (DE)

(72) Inventors: Andreas Emge, Lemfoerde (DE); Sirus Zarbakhsh, Ludwigshafen (DE); Berend Eling, Lemfoerde (DE); Andre Meyer, Lemfoerde (DE)

(21) Appl. No.: 16/620,106

(22) PCT Filed: Jun. 7, 2018
(86) PCT No.: PCT/EP2018/065010

§ 371 Date: Dec. 6, 2019

(30) Foreign Application Priority Data
Jun. 7, 2017 (EP) 17174693.6

(51) Int. Cl. C08K 7/14; C08G 18/48; C08G 18/76; C08G 18/32; C08G 18/66; C08G 65/26; C08K 3/04; C08K 7/06

(52) U.S. Cl. CPC C08K 7/14; C08G 18/4816; C08G 18/4829; C08G 18/4891; C08K 7/06; C08G 18/3206; C08G 18/6611; C08G 65/2609; C08K 3/04; C08G 18/7664

(57) ABSTRACT

Provided herein is a process for producing fiber composite materials which includes mixing an isocyanate component A and a polyol component B to afford a reaction mixture, impregnating fibers with the reaction mixture and the curing the impregnated fibers, wherein the polyol component B includes the alkoxylation product of a mixture of fat-based alcohol (i) and at least one OH-functional compound having aliphatically bonded OH groups and an OH functionality of 2 to 4 which is not a fat-based alcohol (ii). The present compound further relates to a fiber composite material obtainable by such a process and using the fiber composite material as a mast.

The present invention relates to a process for producing fiber composite materials which comprises mixing an isocyanate component A and a polyol component B to afford a reaction mixture, impregnating fibers with the reaction mixture and curing the impregnated fibers, wherein the polyol component B comprises the alkoxylation product of a mixture comprising at least one fat-based alcohol (i) and at least one OH-functional compound having aliphatically bonded OH groups and an OH functionality of 2 to 4 which is not a fat-based alcohol (ii). The present invention further relates to a composite material obtainable by such a process and to the use of the fiber composite material as a mast or pipe.

Polyurethane fiber composite materials are known and comprise for example materials produced by vacuum infusion, filament winding processes or pultrusion. In these applications the fiber material is wetted with a polyurethane reaction mixture, for example in an impregnation bath or an impregnation box. The impregnated fiber material is subsequently shaped and cured, for example in an oven. The thus obtained fiber composite materials feature a relatively low material weight coupled with high hardness and stiffness, a high corrosion resistance and good processability. Polyurethane-fiber composite materials are employed for example as exterior car body parts in automotive manufacture, as boat hulls, masts, for example as power masts or telegraph masts, pipes or rotor blades for wind power plants.

This process is very demanding for polyurethane-based resins since rapid curing must be ensured as soon as the fiber material has acquired its final shape while a long open time of the reaction mixture is required to prevent clogging of the impregnation unit. Said process comprises wetting the fibers with the polyurethane reaction mixture in an open bath or a closed impregnation unit. In addition to a long open time, an optimal wetting of the fibers requires a low viscosity of the reaction mixture and a good fiber compatibility. The produced fiber composite material shall moreover have very good mechanical properties such as a high elastic modulus, a high flexural strength, a high tensile strength and a high glass transition temperature.

Known polyurethane systems for producing fiber composite materials are described for example in WO03085022 and WO00/29459.

The production of polyurethane adhesives based on hybrid polyols is likewise described. Thus WO 2014/206779 describes the production of a polyurethane adhesive obtained by reaction of isocyanate with a polyol component comprising a hybrid polyol. This hybrid polyol is produced by alkoxylation of a mixture of castor oil, bisphenol A and sugar. WO 2014/206779 describes that the thus obtained polyurethane adhesives exhibit improved mechanical properties compared to those produced from a polyol mixture composed of the polyols obtained by alkoxylation of the individual components. However, these hybrid polyols have viscosities of about 2000 to 8000 mPas which does not allow rapid and complete wetting of fiber material and thus precludes the use of these hybrid polyols in the production of fiber composite materials.

The present invention accordingly has for its object to provide a process for producing fiber composite materials based on a polyurethane reaction mixture, wherein the polyurethane reaction mixture has a long open time and a low viscosity so that the fiber material may be optimally impregnated while also rapidly curing to a fiber composite material having exceptional mechanical properties.

It has surprisingly been found that this object is achieved by a process for producing fiber composite materials which comprises mixing an isocyanate component A and a polyol component B to afford a reaction mixture, impregnating fibers with the reaction mixture and curing the impregnated fibers, wherein the polyol component B comprises the alkoxylation product of a mixture comprising at least one fat-based alcohol (i) and at least one OH-functional compound having aliphatically bonded OH groups and an OH functionality of 2 to 4 which is not a fat-based alcohol (ii).

In the context of the present invention, OH functionality is to be understood as meaning the number of alcoholic, acylatable OH groups per molecule. If the particular component is composed of a compound having defined molecular structure, the functionality is given by the number of OH groups per molecule. If a compound is producible by ethoxylation or propoxylation of a starter molecule, the OH functionality is given by the number of reactive functional groups, for example OH groups, per starter molecule.

The polyisocyanate component A comprises at least one diisocyanate or polyisocyanate. These comprise all aliphatic, cycloaliphatic and/or aromatic divalent or polyvalent isocyanates known for producing polyurethanes and any desired mixtures thereof. Examples are 4,4′-methanediphenyl diisocyanate, 2,4′-methanediphenyl diisocyanate, the mixtures of monomeric methanediphenyl diisocyanates and higher-nuclear homologs of methanediphenyl diisocyanate (polyphenylenepolymethylene polyisocyanate), tetramethylene diisocyanate, hexamethylene diisocyanate (HDI), the mixtures of hexamethylene diisocyanates and higher-nuclear homologs of hexamethylene diisocyanate (polynuclear HDI), isophorone diisocyanate (IPDI), 2,4- or 2,6-tolylene diisocyanate (TDI) or mixtures of the recited isocyanates. Preference is given to tolylene diisocyanate (TDI), diphenylmethane diisocyanate (MDI) and especially mixtures of diphenylmethane diisocyanate and polyphenylenepolymethylene polyisocyanates. These mixtures are also known as polymeric MDI. The isocyanates may also be modified, for example through incorporation of uretdione, carbamate, isocyanurate, carbodiimide, allophanate and in particular urethane groups.

Also employable as di- and polyisocyanates are isocyanate-containing isocyanate prepolymers. These polyisocyanate prepolymers are obtainable by reacting above-described di- and polyisocyanates with polyols at temperatures of 30° C. to 100° C., preferably at about 80° C., to afford the prepolymer. It is preferable when production of the prepolymers according to the invention comprises using 4,4′-MDI together with uretonimine-modified MDI and commercially available polyols based on polyesters, for example derived from adipic acid, or polyethers, for example derived from ethylene oxide and/or propylene oxide.

Polyols that can be used for producing isocyanate prepolymers are known to those skilled in the art and described for example in “Kunststoffhandbuch, Band 7, Polyurethane” [Plastics Handbook, Volume 7, Polyurethanes], Carl Hanser Verlag, 3rd edition 1993, chapter 3.1. It is preferable to employ as polyols for producing isocyanate prepolymers polyols also described under polyol component B. In particular, no polyisocyanate prepolymers are employed in the polyisocyanate component A.

Particularly preferably employed as di- and polyisocyanates are mixtures of diphenylmethane diisocyanate and polyphenylene polymethylene polyisocyanates.

The polyol component B contains the alkoxylation product of a mixture of fat-based alcohol (i) and an OH-functional compound having aliphatically bonded OH groups and an OH functionality of 2 to 4 (ii). The alkoxylation is preferably carried out by reacting the mixture comprising at least one fat-based alcohol (i) and at least one OH-functional compound having aliphatically bonded OH groups and an OH functionality of 2 to 4 (ii) using a nucleophilic and/or basic catalyst and at least one alkylene oxide. It is preferable when the mixture of the components (i) and (ii) is initially charged into a reaction vessel before addition of the alkylene oxide. Employable alkylene oxides include for example 1,2-butylene oxide, propylene oxide or ethylene oxide. The alkylene oxide preferably comprises propylene oxide and particularly preferably consists of propylene oxide.

The basic and/or nucleophilic catalyst may be selected from the group comprising alkali metal or alkaline earth metal hydroxides, alkali metal or alkaline earth metal alkoxides, tertiary amines, N-heterocyclic carbenes.

It is preferable when the basic and/or nucleophilic catalyst is selected from the group comprising tertiary amines.

It is particularly preferable when the basic and/or nucleophilic catalyst is selected from the group comprising imidazole and imidazole derivatives, very particularly imidazole.

In another preferred embodiment, the basic and/or nucleophilic catalyst is selected from the group comprising N-heterocyclic carbenes, particularly preferably from the group comprising N-heterocyclic carbenes based on N-alkyl- and N-aryl-substituted imidazolylidenes.

In a preferred embodiment, the basic and/or nucleophilic catalyst is selected from the group comprising trimethylamine, triethylamine, tripropylamine, tributylamine, N,N′-dimethylethanolamine, N,N′-dimethylcyclohexylamine, dimethylethylamine, dimethylbutylamine, N,N′-dimethylaniline, 4-dimethylaminopyridine, N,N′-dimethylbenzylamine, pyridine, imidazole, N-methylimidazole, 2-methylimidazole, 1,2-dimethylimidazole, N-(3-aminopropyl)imidazole), 4-methylimidazole, 5-methylimidazole, 2-ethyl-4-methylimidazole, 2,4-dimethylimidazole, 1-hydroxypropylimidazole, 2,4,5-trimethylimidazole, 2-ethylimidazole, 2-ethyl-4-methylimidazole, N-phenylimidazole, 2-phenylimidazole, 4-phenylimidazole, guanidine, alkylated guanidines, 1,1,3,3-tetramethylguanidine, piperazine, alkylated piperazine, piperidine, alkylated pipiridine, 7-methyl-1,5,7-triazabicyclo[4.4.0]dec-5-ene, 1,5-diazobicyclo[4.3.0]non-5-ene, 1,5-diazabicylo[5.4.0]undec-7-ene, preferably imidazole and dimethylethanolamine (DMEOA).

The recited catalysts may be used alone or in any desired mixtures with one another.

The reaction with alkylene oxide is typically carried out at temperatures in the range between 80° C. and 200° C., preferably between 100° C. and 160° C., particularly preferably between 110° C. and 140° C.

When tertiary amines and/or N-heterocyclic carbenes are used as catalysts for the reaction with alkylene oxides, the catalyst concentration based on the mass of the compounds (i) and (ii) is between 50-5000 ppm, preferably between 100 and 1000 ppm, and the catalyst need not be removed from the reaction product after the reaction.

Suitable as fat-based alcohol (i) are preferably those having a hydroxyl number of greater than 100 to less than 500 mg KOH/g, particularly preferably 100 to 300 mg KOH/g and especially 100 to 200 mg KOH/g, and an OH functionality of at least 1. The OH functionality of the fat-based alcohols is preferably in the range from 2 to 3. The OH functionality of the fat-based alcohols is particularly preferably 2.3 to 3 and very particularly preferably 2.6 to 3.

A fat-based alcohol (i) may be a fat, an oil, i.e. a fat liquid at room temperature, a fatty acid or a compound obtained from the abovementioned compounds by physical or chemical modification. In the context of the present invention, aliphatic monocarboxylic acids having more than 7 carbon atoms are fatty acids. Fatty acid glycerides are referred to as fats/oils. An example of a natural fat-based alcohol according to the abovementioned definition is castor oil.

Contemplated fat-based alcohols (i) include for example vegetable oils or derivatives thereof to the extent that these meet the abovementioned conditions in respect of OH number and OH functionality. Vegetable oils can vary in their composition and exist in various grades of purity. Preferred in the context of the present invention are vegetable oils that satisfy the provisions of the German Pharmacopeia (Deutsches Arzneibuch, DAB). Component a1) very particularly preferably comprises at least one fat-based polyol which is a vegetable oil and complies with DAB-10.

Employable fat-based alcohols (i) further include well-known fatty acids, preferably natural fatty acids, particularly preferably vegetable fatty acids, especially unsaturated vegetable fatty acids, and also derivatives thereof such as esters with alcohols, preferably mono-, di- and/or trialcohols, to the extent that they fulfill the further properties in respect of molecular weight and OH functionality.

Also employable as fat-based alcohol (i) are for example ring-opened epoxidized or oxidized fatty acid compounds. Preference is given to hydroxylated fatty acids and/or hydroxylated fatty acid derivatives obtainable by the abovementioned processes, with castor oil or derivatives of ricinoleic acid being particularly preferred as the fat-based alcohol. Such fat-based alcohols are known per se to those skilled in the art or are obtainable by methods known per se.

Castor oil is a renewable raw material and is obtained from the seeds of the castor bean plant. Castor oil is essentially a triglyceride of a fatty acid mixture comprising, based on the total weight of the fatty acid mixture, >75% by weight of ricinoleic acid, 3% to 10% by weight of oleic acid, 2% to 6% by weight of linoleic acid, 1% to 4% by weight of stearic acid, 0% to 2% by weight of palmitic acid and optionally small amounts of in each case less than 1% by weight of further fatty acids, such as linolenic acid, vaccenic acid, arachidic acid, and eicosenoic acid. Alternatively, a portion of castor oil may also be substituted by ricinoleic acid. The proportion of ricinoleic acid is preferably not more than 40% by weight, particularly preferably 20% by weight, more preferably 10% by weight and in particular 5% by weight, in each case based on the total weight of the component (i). The proportion of the component (i) in the total weight of the mixture to be alkoxylated is preferably 10% to 90% by weight, more preferably 20% to 80% by weight, particularly preferably 30% to 70% by weight and in particular 40% to 60% by weight, in each case based on the total weight of the components (i) and (ii).

Contemplated OH-functional compounds having aliphatically bonded OH groups and an OH functionality of 2 to 4 (ii) include compounds which comprise 2, 3 or 4 OH groups and do not fall under the definition of the fat-based alcohols (i). These compounds (ii) preferably do not have any aromatic groups. Examples include water, propylene glycol, ethylene glycol, diethylene glycol, dipropylene glycol, neopentyl glycol, 1,2-butanediol, 1,3-butanediol, 1,4-butanediol, hexanediol, pentanediol, 3-methyl-1,5-pentanediol, 1,12-dodecanediol, glycerol, trimethylolpropane, pentaerythritol, 1,2,4- or 1,3,5-trihydroxycyclohexane and also reaction products of such compounds with alkylene oxides such as propylene oxide or ethyleneoxide and mixtures thereof.

The component (ii) may further comprise OH-comprising esters and/or polyesters. Esters and polyesters are preferably obtained from organic dicarboxylic acids having 2 to 12 carbon atoms, preferably aliphatic dicarboxylic acids having 4 to 6 carbon atoms and polyhydric alcohols, preferably diols, having 2 to 12 carbon atoms, preferably 2 to 6 carbon atoms. Contemplated dicarboxylic acids include for example: succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids may be used either individually or in admixture with one another. Instead of the free dicarboxylic acids it is also possible to use the corresponding dicarboxylic acid derivatives, for example dicarboxylate esters of alcohols having 1 to 4 carbon atoms or dicarboxylic anhydrides. It is preferable to use dicarboxylic acid mixtures of succinic acid, glutaric acid, adipic acid and especially adipic acid. Examples of di- and polyhydric alcohols, especially diols, are for example ethanediol, diethylene glycol, 1,2- and 1,3-propanediol, dipropylene glycol, 1,4-butanediol, 1,5-pentanediol, 1,6-hexanediol, 1,10-decanediol, glycerol and trimethylolpropane. Preference is given to using ethanediol, diethylene glycol, 1,4-butanediol, 1,5-pentanediol, and 1,6-hexanediol. Also employable are polyester polyols derived from lactones, for example ε-caprolactone, or hydroxycarboxylic acids, for example w-hydroxycaproic acid. Production of the ester/polyester is carried out in known fashion.

The component (ii) preferably has an OH number of at least 50 mg KOH/g, particularly preferably at least 200 mg KOH/g and in particular at least 600 mg KOH/g. It is particularly preferable when compounds employed as aliphatic polyol (ii) have 3 OH groups. A particularly preferred example of a compound of component (ii) is glycerol, trimethylolpropane or pentaerythritol, in particular glycerol or trimethylolpropane. Fat-based alcohols (i) are not regarded as compounds of component (ii).

The proportion of the component (ii) in the total weight of the mixture to be alkoxylated is preferably 10% to 90% by weight, more preferably 20% to 80% by weight, particularly preferably 30% to 70% by weight and in particular 40% to 60% by weight, in each case based on the total weight of the components (i) and (ii).

The alkoxylation of the mixture of the components (i) and (ii) is typically performed with the corresponding amount of alkylene oxide until an OH number of 300 to 600 mg KOH/g, preferably 400 to 550 mg KOH/g, is established. This comprises establishing an OH number such that the viscosity of the obtained alkoxylation product at 23° C. is preferably less than 1500 mPas, particularly preferably 600 to 1200 mPas and especially 600 to 1000 mPas (DIN 53019).

Further triglycerides of fatty acids, such as fish oil, tallow, soybean oil, rapeseed oil, olive oil, sunflower oil, palm kernel oil and mixtures thereof, may also be present in addition to castor oil.

It is preferable when the mixture to be alkoxylated comprises not only the compounds (i) and (ii) but also less than 10% by weight, particularly preferably less than 5% by weight and in particular less than 3% by weight, in each case based on the total weight of the compounds (i) and (ii), of organic compounds comprising isocyanate-reactive groups, in particular OH groups, which do not fall under the definition of the components (i) and (ii). It is very particularly preferable to employ less than 3% by weight and in particular 0% by weight of aromatic di- or polyol. An aromatic di- and polyol is a compound comprising at least 2 OH groups which contains at least one aromatic group.

In addition to the alkoxylation product according to the invention, the polyol component B may contain further polyols. These comprise polyetherols and/or polyesterols. Polyetherols and polyesterols are known and described for example in “Kunststoffhandbuch, Band 7, Polyurethane”, Carl Hanser Verlag, 3rd edition, 1993, chapter 3.1. In a preferred embodiment, the proportion of the alkoxylation product of the components (i) and (ii) based on the total weight of all organic compounds having isocyanate-reactive groups in the polyol component B is at least 20% by weight, more preferably at least 40% by weight, particularly preferably at least 80% by weight and in particular at least 90% by weight.

The polyol component B according to the invention may further comprise customary additives, such as solvents, plasticizers, fillers, such as carbon black, chalk and talcs, adhesion promoters, in particular silicon compounds, such as trialkoxysilanes, thixotropic agents, such as amorphous silicas, and drying agents, such as zeolites.

In the production of the fiber composite materials according to the invention in a first step an isocyanate component A and a polyol component B are mixed to afford a reaction mixture. The mixing is preferably carried out at an isocyanate index of 80 to 200, particularly preferably 90 to 150, more preferably 95 to 120 and in particular 98 to 110. In the context of the present invention the isocyanate index is to be understood as meaning the stoichiometric ratio of isocyanate groups to isocyanate-reactive groups multiplied by 100. Mixing may be carried out mechanically using a stirrer or a stirring screw or under high pressure in what is known as the countercurrent injection process. In the context of the present invention a reaction mixture is to be understood as meaning the mixture of the isocyanate component A and a polyol component B at reaction conversions of less than 90% based on the isocyanate groups.

In a further step fibers are impregnated with the reaction mixture, i.e. the reaction mixture is applied to the fibers/the fibers are saturated with the reaction mixture. This is preferably carried out at a temperature of less than 80° C., particularly preferably 10° C. to 60° C., in particular 15° C. to 40° C., by known impregnation processes, for example in an open impregnation bath (U.S. Pat. Nos. 2,433,965, 4,267,007, US2006177591) or a closed impregnation bath (U.S. Pat. No. 5,747,075).

Preferably employed fibers include glass fibers, carbon fibers, polyester fibers, natural fibers, such as cellulose fibers, aramid fibers, nylon fibers, basalt fibers, boron fibers, zylon fibers (poly(p-phenylene-2,6-benzobisoxazole), silicon carbide fibers, asbestos fibers, metal fibers and combinations thereof, the use of glass fibers and/or carbon fibers being preferred. It is preferable when the fiber material is selected from so-called “endless fibers” which have a length of several meters to several kilometers and are typically unwound from spools. Said fibers may also be in the form of glass fiber rovings or glass fiber mats. The fiber material wetted with the reaction mixture is subsequently made into a desired shape and cured. In the pultrusion process for example this may be effected by introducing the fiber strand into a heated mold. It is preferable when the shaping process is effected by winding the fiber material impregnated with reaction mixture onto a shaping article, for example a spool. In the so-called filament winding process the winding is effected by winding the wetted fibers onto the spool at different angles under tension. The fiber composite material is subsequently cured, for example at an elevated temperature of for example 100° C. to 250° C., preferably 120° C. to 200° C.

The present invention further relates to a fiber composite material obtainable by a process according to the invention. Fiber composite materials according to the invention may for example be used as exterior car body parts in automotive manufacture, as boat hulls, masts, for example as power masts or telegraph masts, as pipes or as rotor blades for wind power plants.

One advantage of the process according to the invention is that the alkoxylation product of the components (i) and (ii) makes it possible to react to afford a homogeneous reaction product compounds which feature a very large polarity difference and are therefore incompatible with one another in pure form. The reaction with alkylene oxide compatibilizes the mutually incompatible molecules, thus resulting in homogeneous reaction products comprising both polyether units and polyester units. In the base-catalyzed alkoxylation this is thought to be attributable to transesterification reactions which ensure homogeneous distribution of the ester-bearing molecule chains with the ether-bearing molecule chains taking place simultaneously and in addition to the ring opening polymerization in the process. This affords polyurethane resins not only having exceptional properties during processing, such as a long open time and a good wettability of the fiber material, but also having exceptional mechanical properties of the fiber composite material itself.

The invention shall be illustrated hereinbelow with reference to examples.

Raw materials employed:
Polyol 1: Polyetherol based on glycerol as the starter molecule and propylene oxide having a hydroxyl number of 805 mg KOH/g and a viscosity at 25° C. of 1275 mPas
Polyol 2: Propoxylated castor oil having a hydroxyl number of 136 mg KOH/g and a viscosity at 25° C. of 852 mPas
Polyol 3: Propoxylation product according to polyol synthesis example 1 having a hydroxyl number of 483 mg KOH/g and a viscosity at 23° C. of 775 mPas
Iso 1: Polymeric MDI having a functionality of about 2.7 and an NCO content of 31.5% by weight obtainable under the trade name Lupranat® M20 from BASF SE
Water scavenger: Zeolytic water scavenger dispersed in castor oil (50% by weight)
Defoamer: defoamer based on silicone.

### POLYOL SYNTHESIS EXAMPLES 1

### Polyol Synthesis Example 1 (Synthesis 1)

94 kg of glycerol, 0.040 kg of aqueous imidazole solution (50% by weight) and 118.0 kg of castor oil (FSG quality) were initially charged into a 600 L reactor at 25° C. This was then inertized with nitrogen. The vessel was heated to 150° C. and 188.0 kg of propylene oxide were added. After a reaction time of 10 h the reactor was evacuated for 40 minutes under complete vacuum at 100° C. and then cooled down to 25° C. 392.0 kg of product were obtained.

The obtained polyether ester had the following characteristics:
OH number: 483 mg KOH/g
Viscosity (25° C.): 775 mPas
Acid number: 0.03 mg KOH/g
Water content: 0.03% by weight

Polyols having identical hydroxyl numbers were produced by mixing the recited polyols with water scavengers and defoamers according to table 1. These were mixed with Iso 1 at an isocyanate index of 120 to afford a reaction mixture from which polyurethane test sheets having dimensions of 200×300×2 mm were cast. It was found that for identical OH numbers the hardness, flexural strength, flexural elastic modulus, tensile strength and tensile elastic modulus of the test sheet were markedly improved using the hybrid polyol. The open time of the reaction mixture was also approximately doubled from 21.5 minutes to 40 minutes when using the hybrid polyol.

TABLE 1

| | Polyol | Hybrid |
|---|---|---|
| | mixture | polyol |
| Polyol 1 | 49.8 | |
| Water scavenger | 5 | 5 |
| Defoamer | 0.2 | 0.2 |
| Polyol 3 | | 94.8 |
| Polyol 2 | 45 | |
| | 100 | 100 |
| OHN of polyol component | 462.09 | 464.52 |
| Iso 1 | X | X |
| Hardness [Shore D] | 79 | 81 |
| Flexural strength [MPa] | 86 | 115 |
| Flexural elastic modulus [MPa] | 1937 | 2521 |
| Elongation [MPa] | 66 | 81 |
| Elongation at break [%] | 9.1 | 8.5 |
| Elongation elastic modulus | 2210 | 3005 |
| Tg (DSC) | | |
| Open time (Geltimer) [min] | 21.5 | 40 |

1. A process for producing fiber composite materials which comprises:
mixing an isocyanate component A and a polyol component B to afford a reaction mixture,
impregnating fibers with the reaction mixture, and
curing the impregnated fibers, wherein the polyol component B comprises the alkoxylation product of a mixture comprising (i) at least one fat-based alcohol and (ii) at least one OH-functional compound having aliphatically bonded OH groups and an OH functionality of 2 to 4 that is not a fat-based alcohol.

2. The process according to claim 1, wherein alkoxylation to produce the alkoxylation product of the mixture comprising (i) at least one fat-based alcohol and (ii) at least one OH-functional compound having aliphatically bonded OH groups and an OH functionality of 2 to 4 that is not a fat-based alcohol is carried out using at least one of a nucleophilic and a basic catalyst and at least one alkylene oxide.

3. The process according to claim 1, wherein the fat-based alcohol comprises castor oil.

4. The process according to claim 1, wherein the alkylene oxide comprises propylene oxide.

5. The process according to claim 1, wherein the OH-functional compound comprises 3 OH groups.

6. The process according to claim 1, wherein the OH-functional compound is at least one of glycerol and trimethylolpropane.

7. The process according to claim 1, wherein an OH number of the alkoxylation product of the mixture of (i) at least one fat-based alcohol and (ii) at least one OH-functional compound having aliphatically bonded OH groups and an OH functionality of 2 to 4 is 300 to 600 mg KOH/g.

8. The process according to any of claim 1, wherein a viscosity of the alkoxylation product of the mixture of (i) at least one fat-based alcohol and (ii) at least one OH-functional compound having aliphatically bonded OH groups and an OH functionality of 2 to 4 is less than 1500, measured according to DIN 53019.

9. The process according to claim 1, wherein a proportion of (i) the at least one fat-based alcohol is 10% to 90% by weight and a proportion of (ii) the at least one OH-functional compound having aliphatically bonded OH groups and an OH functionality of 2 to 4 is 90% to 10% by weight in each case based on the total weight of the components (i) and (ii).

10. The process according to claim 1, wherein the fibers employed are endless fibers of glass or carbon fiber.

11. The process according to claim 1, wherein the proportion of fiber material is 30% to 90% by weight based on the total weight of the fiber composite material.

12. The process according to claim 1, wherein the isocyanate component A comprises a mixture of monomeric diphenylmethane diisocyanate and higher-nuclear diphenylmethane diisocyanate.

13. The process according to claim 1, wherein the impregnated fibers are wound up before curing.

14. A fiber composite material obtainable by a process according to claim 1.

15. A method of using the fiber composite material according to claim 14, wherein the method comprises:
utilizing the fiber composite material as one of a mast and a pipe.
